(19) United States
(12) Patent Application Publication
(10) Pub. No.: US 2014/0304087 A1
(43) Pub. Date: Oct. 9, 2014

(54) SYSTEM AND METHOD FOR APPLYING TARGETED AUDIENCE BID MODIFIERS

(71) Applicant: AppNexus Inc., New York, NY (US)

(72) Inventors: David M. Himrod, New York, NY (US); Scott Nowers, New York, NY (US)

(21) Appl. No.: 14/213,799

(22) Filed: Mar. 14, 2014

Related U.S. Application Data
(60) Provisional application No. 61/793,308, filed on Mar. 15, 2013.

(51) Int. Cl. G06Q 30/02

(52) U.S. Cl. CPC G06Q 30/0275
USPC 705/14.71

(57) ABSTRACT

Method and system for modifying bids for impressions in an online advertising platform. A target audience definition and a bid modifier value are received from a user of the advertising platform using a platform interface, and the bid modifier value is associated with the target audience definition. A call for an advertisement to be served to an impression consumer is received, and the impression consumer is determined to be included in the target audience definition. The bid modifier is then applied to a bid price generated in response to the call.

### CROSS-REFERENCE TO RELATED APPLICATION

This application claims priority to and the benefit of U.S. Provisional Patent Application No. 61/793,308, filed on Mar. 15, 2013, and entitled “System and Method for Applying Targeted Audience Bid Modifiers,” the entirety of which is incorporated by reference herein.

### BACKGROUND INFORMATION

The present disclosure relates generally to real-time online advertising auctions and, in particular, to a method and system for modifying bids for impressions in an online advertising platform.

The effectiveness of an advertising campaign can be measured using various performance metrics, such as return on investment (ROI). To maximize ROI when utilizing a real-time bidding online advertising platform, it is desirable to display the creatives of an advertising campaign on impression inventory that allows for a sufficient number of auction wins while staying within an advertising budget. To determine a bidding strategy that will achieve these goals, the platform can engage in various learning operations on behalf of the advertiser. In some circumstances, however, the advertiser itself has access to its own bid optimization data that accounts for factors that the advertising platform may not consider. To date, however, there is no easy way to utilize an advertiser's data in conjunction with data gathered by the advertising platform in order to optimize a bidding strategy.

### SUMMARY

Systems and methods are presented for modifying bids for impressions in an online advertising platform. In one aspect, a computer-implemented method includes receiving, from a user of an online advertising platform, a target audience definition and a bid modifier value; associating the bid modifier value with the target audience definition; receiving a call for an advertisement to be served to an impression consumer; determining that the impression consumer is included in the target audience definition; and applying the bid modifier value to a bid price generated in response to the call, thereby creating a final bid price.

In one implementation, the bid modifier includes a modifying factor, and applying the bid modifier value to the bid price includes adjusting the bid price based on the modifying factor. The bid modifier can also include an override price, and applying the bid modifier value to the bid price can include replacing the bid price with the override price. The bid modifier can be based on at least one of a time, weather, a domain, an ad frequency, and an ad recency.

In another implementation, the method further includes receiving, from the user, a second target audience definition. The bid modifier value can be associated with the second target audience definition. The method can further include receiving, from the user, a second bid modifier value; and associating the second bid modifier value with the second target audience definition. The method can further include determining that the impression consumer is included in the second target audience definition. Applying the bid modifier value to the bid price can include selecting at least one of the first bid modifier value and the second bid modifier value to apply to the bid price.

In a further implementation, the method further includes associating the bid modifier value with an advertising campaign. The bid modifier value can be associated with an individual member of a target audience such that a bid price calculated in an auction to serve an advertisement to the individual audience member is different relative to bid prices that would be calculated in the auction to serve the advertisement to other members of the target audience.

In another aspect, a system includes one or more computers programmed to perform operations including receiving, from a user of an online advertising platform, a target audience definition and a bid modifier value; associating the bid modifier value with the target audience definition; receiving a call for an advertisement to be served to an impression consumer; determining that the impression consumer is included in the target audience definition; and applying the bid modifier value to a bid price generated in response to the call, thereby creating a final bid price.

In one implementation, the bid modifier includes a modifying factor, and applying the bid modifier value to the bid price includes adjusting the bid price based on the modifying factor. The bid modifier can also include an override price, and applying the bid modifier value to the bid price can include replacing the bid price with the override price. The bid modifier can be based on at least one of a time, weather, a domain, an ad frequency, and an ad recency.

In another implementation, the operations further include receiving, from the user, a second target audience definition. The bid modifier value can be associated with the second target audience definition. The operations can further include receiving, from the user, a second bid modifier value; and associating the second bid modifier value with the second target audience definition. The operations can further include determining that the impression consumer is included in the second target audience definition. Applying the bid modifier value to the bid price can include selecting at least one of the first bid modifier value and the second bid modifier value to apply to the bid price.

In a further implementation, the operations further include associating the bid modifier value with an advertising campaign. The bid modifier value can be associated with an individual member of a target audience such that a bid price calculated in an auction to serve an advertisement to the individual audience member is different relative to bid prices that would be calculated in the auction to serve the advertisement to other members of the target audience.

The details of one or more implementations of the subject matter described in the present specification are set forth in the accompanying drawings and the description below. Other features, aspects, and advantages of the subject matter will become apparent from the description, the drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 is a flowchart of a method for modifying bids for impressions in an online advertising platform according to an implementation.

### DETAILED DESCRIPTION

In various implementations, the present system allows users of an online advertising platform having real-time bidding features to influence the valuation of bids on impression inventory using their own data about impression consumers. This functionality is accomplished through the use of target audience bid modifiers, referred to herein as “segment modifiers,” which allow a user to combine the platform bidding technology with the user's own data, facilitating the formation of precise bid valuations in real-time. As used herein, “segments” are groups of identified members of a target audience. The audience members can be identified based on webpages they visit or actions they have taken, and/or on data associated with the members such as demographics (gender, income, age range, etc.), geography (country, region, state, etc.), and other identifying attributes.

The online advertising platform can include a transaction management computing subsystem, also referred to as a “platform impression bus,” that facilitates the transaction aspects of impression inventory trading. In general, the platform impression bus can process requests for ads to be served to impression consumers, conduct impression auctions, return ads to publishers, provide auction result data, and enforce quality standards.

Users of the platform can be impression seller members, impression buyer members, and/or bidders. Impression seller members are persons or entities that sell impression inventory (e.g., publishers selling ad space). Impression buyer members are persons or entities that purchase impression inventory (e.g., advertisers buying ad space). To buy impression inventory, an impression buyer can engage a decisioning computing subsystem (e.g., a bidder) to operate on its behalf. The term “bidder” generally refers to a piece of technology rather than an entity that operates it, and includes a bidding engine that takes various pieces of bid-specific information as input and generates a bid for a particular item of impression inventory on behalf of an impression buyer member. Bidding logic can be provided by impression buyers, the advertising platform, or other parties.

In one example of the operation of the advertising platform, an impression seller hosts a website that provides a number of creative serving opportunities. As an impression consumer's web browser is rendering the page from the website that has an ad serving opportunity, an ad call is made to the platform impression bus as part of the page content. A real-time bidding auction can then be held among advertisers to determine who will be permitted to serve a creative to the impression consumer. Alternatively, an advertiser may have arrangements with the advertising platform and/or publishers (e.g., direct impression inventory purchases) such that the advertiser's creatives are served directly to the consumer.

In one implementation, impression bids can be adjusted using segment modifiers based on time-of-day, weather, domain, ad recency, ad frequency, or other suitable targeting parameters. For example, an advertiser for a streaming video service may desire to target regions of the country that are currently experiencing bad weather. In such a case, segment modifiers can be used such that bids for ads to be served to impression consumers within those regions are increased by a factor configurable by the advertiser.

In a real-time auction for an impression to be served to an impression consumer in a targeted audience, a segment modifier can be a modifying factor used to manipulate bids calculated by the advertising platform. Specifically, the segment modifier can use the calculated bid valuation as a starting point, but increase or decrease the bid amount depending on a valuation of the impression consumer derived from the platform user's data. For example, the segment modifier can be a modifying factor that takes the form of a multiplier that can increase a bid by a percentage (i.e., multiplier>1) or decrease a bid by a percentage (i.e., multiplier <1). Segment modifiers can work well for campaigns having medium-to-high budgets, long or repeating flight dates, or click-conversion performance metrics.

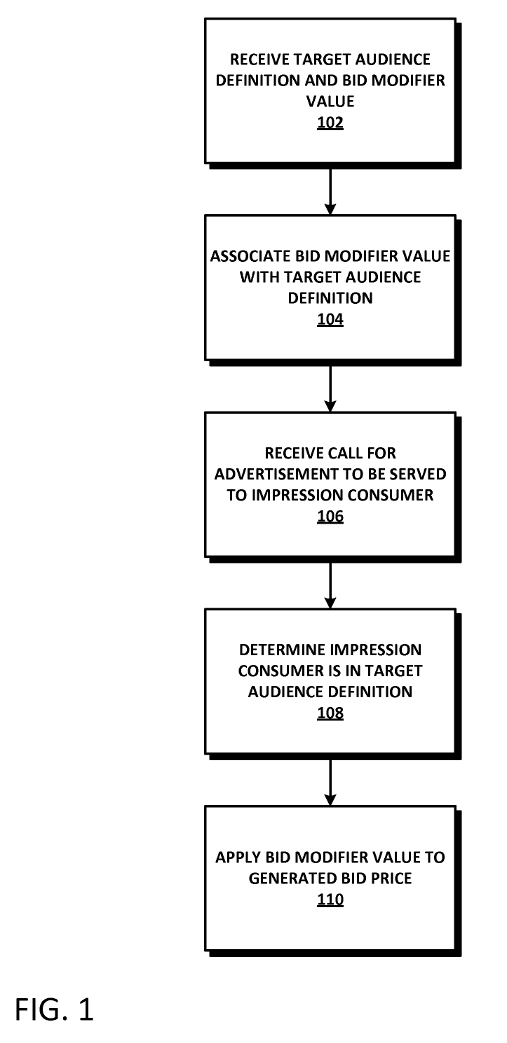

Referring to FIG. 1, in one implementation, a method for modifying a bid for an impression in an online advertising auction platform includes receiving a target audience definition and a bid modifier value from a user of the platform (STEP 102). The bid modifier value is associated with the target audience definition (STEP 104). A call is received for an advertisement to be served to an impression consumer (STEP 106), and a determination is made that the impression consumer is included in the target audience definition (STEP 108). A final bid price is then created by applying the bid modifier value to a bid price generated in response to the call (STEP 110).

In some instances, rather than using a segment modifier, a “segment price” is used as a direct override to the bid price (i.e., the platform user specifies the absolute bid that should be submitted). Segment prices can work well for short campaigns with high budgets which, due to their short flight dates, may not generate enough data to attain an optimized state.

To ensure that users of the advertising platform can use segment modifiers without substantial difficulty, an interface, or API, that hides complexities from the users is used. Consider, for example, that a platform user desires to adjust bids with different multipliers depending on the audience segment group that an impression consumer falls into. The user can define a modifier segment that specifies audience segments and associated modifier values, as shown in Table 1. As shown, if the impression consumer has not visited Website 1, the bid price calculated by the advertising platform will be reduced to 90% of its value, whereas for a consumer that has recently visited eBay, the bid price is multiplied fivefold. Such a configuration can be desirable if, for example, the advertiser's goal is to target consumers having a propensity to participate in online auctions.

TABLE 1

| Audience Segment | Audience | Modifier |
|---|---|---|
| A | Male | A: 2 |
| B | Age 25-40 | B: 3 |
| C | Located outside U.S. | C: 0.5 |
| D | Non-eBay visitors | D: 0.9 |
| E | Recent eBay visitors | E: 5 |

In some implementations, only one modifier segment is assigned to a campaign. Thus, for a campaign that uses segment modifier A from Table 1, a bid for an advertisement to be served to an impression consumer that is an identified member of that audience segment will be multiplied by 2. On the other hand, for that uses segment modifier C, impression bids are multiplied by 0.5 if the impression consumer is included in that audience segment. As a result, relative distinctions between individual impression consumers can be made within the campaign.

In other implementations, multiple modifier segments can be assigned to a single campaign. Consider, for example, that an impression consumer is identified as included in Audience Segment B in the above example, but also identified as included in Audience Segment G in another modifier that is associated with the same campaign. In one implementation, only a single modifier is chosen to be applied to the impression bid. For example, the modifier can be a random selection from the applicable modifiers, the modifier that increases the bid the most (or least), the modifier than decreases the bid the most (or least), the modifier belonging to a segment with the highest priority or other suitable manner of selection. In other implementations, the applicable modifiers can be combined by, for example, addition or multiplication. The resulting modifier can be limited by a configurable minimum and/or maximum modifier value.

To enable the use of segment modifiers and/or segment prices, platform users can upload to the advertising platform a list of segment modifiers and/or prices and associated audience segment groups (i.e., definitions of target audiences that share one or more characteristics), and/or can provide this information through real-time data provider integration with the platform. The segment modifiers/prices and audience segments can be uploaded to the platform using a batch transfer service. The modifiers/prices can follow a format defined by the batch transfer service. For example, the modifier and price values can be floating-point numbers specified in integer form by multiplying the value by 1000. That is, to specify a segment price of $0.75, the integer “750” is specified into the appropriate field of the segment data file.

Following upload, each segment modifier/price can be associated with an advertising campaign via the platform interface. To perform the association, a platform user can include an identifier associated with the modifier/price as a parameter to a campaign creation/modification function of the platform. In some implementations a modifier/price segment is only associated with a single audience segment; however, an audience segment can be associated with more than one modifier segment. Further, in some implementations, platform users are limited to one segment modifier and/or segment price per advertising campaign. In other implementations, however, more complex combinations of segment modifiers are employed, such as permitting multiple modifiers per advertising campaign. For example, multiple segment modifiers can be combined together in various manners to form a total multiplier (which can be limited by a minimum/maximum range specified by the platform user).

Segment modifiers and/or prices can be associated with individual members of the target audience; that is, one or more members within an audience segment can have a unique modifier that results in a calculated impression bid being different relative to other bids calculated for advertisements to be served to other members of the audience. The individual members can be identified by any suitable tracking method, such as cookies or fingerprinting. Once identified, the bid modifier or price associated with the member can be applied in auctions for impressions to be served to that member. In some implementations, to achieve complete overlap, all members in the target audience (across one or all audience segments) have an associated segment modifier/price value.

Through the segment modifier interface, a platform user can indicate what action should be taken when a request is received to submit a bid for an impression and the user has not associated a segment modifier or segment price with the target audience for the impression (in some implementations, either a segment modifier or a segment price can be associated with an audience segment, but not both). More specifically, the user can configure the bidding system in the advertising platform to either (1) submit a bid with no segment modifier/price applied; (2) submit a bid with a default or platform-determined modifier/price applied; or (3) not submit a bid at all.

If the platform user has associated a segment modifier or segment price with a target audience segment but has failed to specify an actual modifier/price value, or if the audience segment is not associated with any segment modifier/price, a default value can be applied (e.g., a multiplier of 1 or other platform- or user-configured value). The default value can be limited to a floating point value between 0 and 1. In some implementations, a value of 0 can be used to indicate that no bid should be submitted when no value has been specified for the segment modifier/price. Further, platform users can configure minimum and maximum values for bid modifiers such that unexpectedly large or small bids are not submitted.

The segment modifier interface can also include a “weighting” feature that enables platform users to vary the rate at which a modifier can influence bid pricing. This allows users to make changes to their campaigns without waiting for segment modifier/price values to be updated with the user's latest bid pricing data. For example, the weight can be a floating-point multiplier that is applied to a segment modifier/price value when the modifier/price would otherwise normally be applied to a bid price.

Ultimately, during an auction for an advertisement to be served to an impression consumer, the platform performs a lookup for the consumer in both the audience segments and modifier/price segments and applies the associated modifier to the bid valuation determined by the platform (or overrides it completely with a segment price, if used).

Implementations of the system described herein can use appropriate hardware or software; for example, the system can execute on hardware capable of running an operating system such as the Microsoft Windows® operating systems, the Apple OS X® operating systems, the Apple iOS® platform, the Google Android™ platform, the Linux® operating system and other variants of UNIX® operating systems, and the like.

Some or all of the functionality described herein can be implemented in software and/or hardware. Such hardware can include, but is not limited to, a smart phone, smart watch, smart glasses, tablet computer, portable computer, television, gaming device, music player, mobile telephone, laptop, palmtop, smart or dumb terminal, network computer, personal digital assistant, wireless device, information appliance, workstation, minicomputer, mainframe computer, or other computing device, that is operated as a general purpose computer or a special purpose hardware device that can execute the functionality described herein. The software, for example, can be implemented on a general purpose computing device in the form of a computer including a processing unit, a system memory, and a system bus that couples various system components including the system memory to the processing unit.

Additionally or alternatively, some or all of the functionality can be performed remotely, in the cloud, or via software-as-a-service. For example, certain functions can be performed on one or more remote servers or other devices that communicate with client devices. The remote functionality can execute on server class computers that have sufficient memory, data storage, and processing power and that run a server class operating system (e.g., Oracle® Solaris®, GNU/Linux®, and the Microsoft® Windows® family of operating systems).

The system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application, implemented in a suitable programming language or framework.

Method steps of the techniques described herein can be performed by one or more programmable processors executing one or more computer programs to perform functions by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

A communications network can connect client devices with one or more remote servers and/or with each other. The communication can take place over media such as standard telephone lines, LAN or WAN links (e.g., T1, T3, 56kb, X.25), broadband connections (ISDN, Frame Relay, ATM), wireless links (802.11 (Wi-Fi), Bluetooth, GSM, CDMA, etc.), for example. Other communication media are possible. The network can carry TCP/IP protocol communications, and HTTP/HTTPS requests made by a web browser, and the connection between the client devices and servers can be communicated over such TCP/IP networks. Other communication protocols are possible.

In various implementations, a client device includes a web browser, native application, or both, that facilitates execution of the functionality described herein. A web browser allows the device to request a web page or other downloadable program, applet, or document (e.g., from the remote server(s) or other server, such as a web server) with a web page request. One example of a web page is a data file that includes computer executable or interpretable information, graphics, sound, text, and/or video, that can be displayed, executed, played, processed, streamed, and/or stored and that can contain links, or pointers, to other web pages. In one implementation, a user of the client device manually requests a web page from the server. Alternatively, the device automatically makes requests with the web browser. Examples of commercially available web browser software include Microsoft® Internet Explorer®, Mozilla® Firefox®, and Apple® Safari®.

In some implementations, the client devices include client software. The client software provides functionality to the device that provides for the implementation and execution of the features described herein. The client software can be implemented in various forms, for example, it can be in the form of a native application, web page, widget, and/or Java, JavaScript, .Net, Silverlight, Flash, and/or other applet or plug-in that is downloaded to the device and runs in conjunction with the web browser. The client software and the web browser can be part of a single client-server interface; for example, the client software can be implemented as a plug-in to the web browser or to another framework or operating system. Other suitable client software architecture, including but not limited to widget frameworks and applet technology can also be employed with the client software.

The system can also be practiced in distributed computing environments where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems such as those mentioned above, and that operate on one or more computers having hardware such as that described herein.

In some cases, relational or other structured databases can provide such functionality, for example, as a database management system which stores data for processing. Examples of databases include the MySQL Database Server or ORACLE Database Server offered by ORACLE Corp. of Redwood Shores, Calif., the PostgreSQL Database Server by the PostgreSQL Global Development Group of Berkeley, California, or the DB2 Database Server offered by IBM.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The terms and expressions employed herein are used as terms and expressions of description and not of limitation, and there is no intention, in the use of such terms and expressions, of excluding any equivalents of the features shown and described or portions thereof. In addition, having described certain implementations of the invention, it will be apparent to those of ordinary skill in the art that other implementations incorporating the concepts disclosed herein can be used without departing from the spirit and scope of the invention. The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

1. A computer-implemented method comprising:
receiving, from a user of an online advertising platform, a target audience definition and a bid modifier value;
associating the bid modifier value with the target audience definition;
receiving a call for an advertisement to be served to an impression consumer;
determining that the impression consumer is included in the target audience definition; and
applying the bid modifier value to a bid price generated in response to the call, thereby creating a final bid price.

2. The method of claim 1, wherein the bid modifier comprises a modifying factor, and wherein applying the bid modifier value to the bid price comprises adjusting the bid price based on the modifying factor.

3. The method of claim 1, wherein the bid modifier comprises an override price, and wherein applying the bid modifier value to the bid price comprises replacing the bid price with the override price.

4. The method of claim 1, wherein the bid modifier is based on at least one of a time, weather, a domain, an ad frequency, and an ad recency.

5. The method of claim 1, further comprising receiving, from the user, a second target audience definition.

6. The method of claim 5, further comprising associating the bid modifier value with the second target audience definition.

7. The method of claim 5, further comprising:
receiving, from the user, a second bid modifier value; and
associating the second bid modifier value with the second target audience definition.

8. The method of claim 7, further comprising:
determining that the impression consumer is included in the second target audience definition; and
wherein applying the bid modifier value to the bid price comprises selecting at least one of the first bid modifier value and the second bid modifier value to apply to the bid price.

9. The method of claim 1, further comprising associating the bid modifier value with an advertising campaign.

10. The method of claim 1, further comprising associating the bid modifier value with an individual member of a target audience such that a bid price calculated in an auction to serve an advertisement to the individual audience member is different relative to bid prices that would be calculated in the auction to serve the advertisement to other members of the target audience.

11. A system comprising:
one or more computers programmed to perform operations comprising:
receiving, from a user of an online advertising platform, a target audience definition and a bid modifier value;
associating the bid modifier value with the target audience definition;
receiving a call for an advertisement to be served to an impression consumer;
determining that the impression consumer is included in the target audience definition; and
applying the bid modifier value to a bid price generated in response to the call, thereby creating a final bid price.

12. The system of claim 11, wherein the bid modifier comprises a modifying factor, and wherein applying the bid modifier value to the bid price comprises adjusting the bid price based on the modifying factor.

13. The system of claim 11, wherein the bid modifier comprises an override price, and wherein applying the bid modifier value to the bid price comprises replacing the bid price with the override price.

14. The system of claim 11, wherein the bid modifier is based on at least one of a time, weather, a domain, an ad frequency, and an ad recency.

15. The system of claim 11, further comprising receiving, from the user, a second target audience definition.

16. The system of claim 15, wherein the operations further comprise associating the bid modifier value with the second target audience definition.

17. The system of claim 15, wherein the operations further comprise:
receiving, from the user, a second bid modifier value; and
associating the second bid modifier value with the second target audience definition.

18. The system of claim 17, wherein the operations further comprise:
determining that the impression consumer is included in the second target audience definition; and
wherein applying the bid modifier value to the bid price comprises selecting at least one of the first bid modifier value and the second bid modifier value to apply to the bid price.

19. The system of claim 11, wherein the operations further comprise associating the bid modifier value with an advertising campaign.

20. The system of claim 11, wherein the operations further comprise associating the bid modifier value with an individual member of a target audience such that a bid price calculated in an auction to serve an advertisement to the individual audience member is different relative to bid prices that would be calculated in the auction to serve the advertisement to other members of the target audience.
